(19) United States
(12) Patent Application Publication
(10) Pub. No.: US 2014/0236717 A1
(43) Pub. Date: Aug. 21, 2014

(54) ADVERTISING SYSTEM AND ADVERTISING EFFECT DETERMINATION METHOD

(71) Applicant: YAHOO JAPAN CORPORATION, Tokyo (JP)

(72) Inventors: Takayuki TSUCHIYA, Tokyo (JP); Hiroshi OTA, Tokyo (JP); Taku KUSANO, Tokyo (JP)

(73) Assignee: YAHOO JAPAN CORPORATION, Tokyo (JP)

(21) Appl. No.: 14/178,903

(22) Filed: Feb. 12, 2014

(30) Foreign Application Priority Data
Feb. 15, 2013 (JP) 2013-028194

(51) Int. Cl. G06Q 30/02

(52) U.S. Cl. CPC G06Q 30/0261; G06Q 30/0255
USPC 705/14.53; 705/14.58

(57) ABSTRACT

An advertising system according to an embodiment includes a remitting customer side wireless LAN communication unit, an attracting customer side wireless LAN communication unit, and a remitting customer result update unit. The attracting customer side wireless LAN communication unit is arranged at a position corresponding to a digital signage on which advertising content is displayed. The attracting customer side wireless LAN communication unit is arranged in a commercial space. The remitting customer result update unit updates information on a result of remitting customer by the advertising content, when a wireless terminal enters a communication area of the attracting customer side wireless LAN communication unit after entering a communication area of the remitting customer side wireless LAN communication unit is detected.

### CROSS-REFERENCE TO RELATED APPLICATIONS

The present application claims priority to and incorporates by reference the entire contents of Japanese Patent Application No. 2013-028194 filed in Japan on Feb. 15, 2013.

### BACKGROUND OF THE INVENTION

1. Field of the Invention

The present invention relates to an advertising system and an advertising effect determination method.

2. Description of the Related Art

Recently, electronic advertisement media called digital signages to display digital content distributed through a communication network are arranged in various places such as a store, a street, a station, an airport, and a hotel.

Because a digital signage can display advertising content in consideration of an arrangement place or a time zone, the digital signage attracts attention in that provision of information such as a real-time campaign matched with the arrangement place or the time zone can be performed.

Advertisement charges necessary for displaying advertising content on the digital signage are determined by a price according to the display number of times on the digital signage (for example, refer to Japanese Laid-open Patent Publication No. 2012-098992) or are determined by a bidding price in an auction form (for example, refer to Japanese Laid-open Patent Publication No. 2010-182202).

However, in advertisement technology using the digital signage, the advertisement charges are set before the advertising content is displayed on the digital signage. For this reason, even though an actual advertising effect is small, the advertisement charges may become expensive and may not become convincible advertisement charges for an advertiser.

### SUMMARY OF THE INVENTION

According to an exemplary embodiment, an advertising system includes a remitting customer side wireless LAN communication unit, an attracting customer side wireless LAN communication unit, and a remitting customer result update unit. The remitting customer side wireless LAN communication unit is arranged at a position corresponding to a digital signage on which advertising content is displayed. The attracting customer side wireless LAN communication unit is arranged in a commercial space that is an advertisement target of the advertising content. The remitting customer result update unit updates information on a result of remitting customer by the advertising content, when a wireless terminal that enters a communication area of the attracting customer side wireless LAN communication unit after entering a communication area of the remitting customer side wireless LAN communication unit is detected.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a diagram illustrating a configuration of an advertising system according to a first embodiment;

FIG. 1B is a diagram illustrating an advertising effect determination method by the advertising system illustrated in FIG. 1A;

FIG. 2 is a diagram illustrating a specific configuration example of the advertising system according to the first embodiment;

FIGS. 3A and 3B are diagrams illustrating sequences example of session establishment between a wireless LAN access point and a wireless terminal;

FIG. 4 is a diagram illustrating an example of a DS information table stored in an advertising information DB;

FIG. 5 is a diagram illustrating an example of an advertising information table stored in the advertising information DB;

FIG. 6 is a diagram illustrating an example of a detection information data stored in an AP information DB;

FIG. 7 is a diagram illustrating an example of a count determination table stored in the advertising information DB;

FIG. 8 is a flowchart of an information process in the wireless LAN access point;

FIG. 9 is a flowchart of an information process in an advertisement distribution management apparatus;

FIG. 10 is a diagram illustrating a configuration of an advertising system according to a second embodiment;

FIG. 11 is a diagram illustrating an advertising effect determination method by the advertising system illustrated in FIG. 10;

FIG. 12 is a flowchart of an information process in a wireless terminal illustrated in FIG. 10;

FIG. 13 is a flowchart of an information process in the wireless LAN access point illustrated in FIG. 10; and

FIG. 14 is a flowchart of an information process in an advertisement distribution management apparatus illustrated in FIG. 10.

### DETAILED DESCRIPTION OF THE PREFERRED EMBODIMENTS

Hereinafter, embodiments of an advertising system and an advertising effect determination method according to the present application will be described in detail with reference to the drawings. The advertising system and the advertising effect determination method according to the present application are not limited by the embodiments. In addition, a database is referred to as a DB hereinafter.

### 1. First Embodiment

1.1. Advertising System

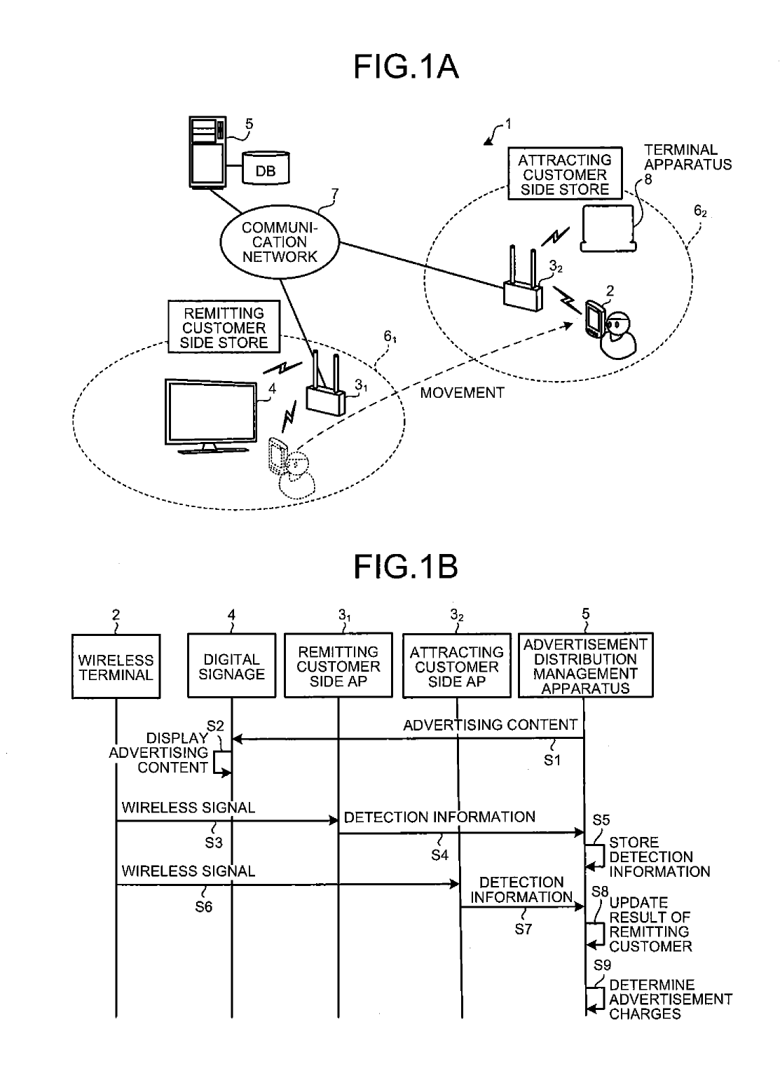

FIG. 1A is a diagram illustrating a configuration of an advertising system according to a first embodiment. As illustrated in FIG. 1A, an advertising system 1 according to the first embodiment includes wireless local area network (LAN) access points 3₁ and 3₂, a digital signage 4, and an advertisement distribution management apparatus 5.

The wireless LAN access points 3₁ and 3₂ and the advertisement distribution management apparatus 5 are connected to enable communication through a communication network 7. The communication network 7 is, for example, a wide area network (WAN) such as the Internet. In addition, the digital signage 4 is connected to the communication network 7 through the wireless LAN access point 3₁.

The wireless LAN access points 3₁ and 3₂ use commercial spaces to provide services such as commerce or the medical profession as wireless LAN communication areas 6₁ and 6₂ (hereinafter, referred to as AP communication areas 6₁ and 6₂). As the commercial spaces, there are event meeting places where concerts and sports are performed, in addition to stores such as retail stores, restaurants, beauty parlors/barbershops, hospitals, hotels, and compound recreation facilities. Here, it is assumed that the wireless LAN access points 3₁ and 3₂ are arranged in the stores such as the retail stores or the restaurants.

The digital signage 4 is arranged in the AP communication area 6₁ of the wireless LAN access point 3₁ and displays advertising content. The advertising content that is displayed on the digital signage 4 is advertising content that corresponds to an arrangement place of the wireless LAN access point 3₂. Thereby, an advertisement service in which an arrangement store of the wireless LAN access point 3₁ is set as a remitting customer side store and an arrangement store of the wireless LAN access point 3₂ is set as an attracting customer side store can be provided.

The advertisement distribution management apparatus 5 acquires the advertising content transmitted from a terminal apparatus 8 of the attracting customer side store through the wireless LAN access point 3₂ and the communication network 7 and transmits the acquired advertising content to the digital signage 4 through the communication network 7 and the wireless LAN access point 3₁.

The advertisement distribution management apparatus 5 acquires information on a wireless terminal 2 transmitted from the wireless LAN access points 3₁ and 3₂ and determines an advertising effect by the advertising content displayed on the digital signage 4, on the basis of the acquired information. Hereinafter, an example of an advertising effect determination method by the advertising system 1 according to the first embodiment will be described with reference to FIG. 1B. FIG. 1B is a diagram illustrating an advertising effect determination method according to the first embodiment.

As illustrated in FIG. 1B, the advertisement distribution management apparatus 5 transmits the advertising content to the digital signage 4 arranged in the AP communication area 6₁ of the wireless LAN access point 3₁ arranged in the remitting customer side store (step S1). The advertising content that is transmitted to the digital signage 4 is information that includes an advertisement regarding the attracting customer side store in which the wireless LAN access point 3₂ is arranged.

If the digital signage 4 acquires the advertising content from the advertisement distribution management apparatus 5, the digital signage 4 displays the advertising content (step S2). If the wireless LAN access point 3₁ acquires a wireless signal from the wireless terminal 2 having entered the AP communication area 6₁, in a state in which the advertising content is displayed on the digital signage 4 (step S3), the wireless LAN access point 3₁ transmits detection information including the information on the wireless terminal 2 to the advertisement distribution management apparatus 5 (step S4).

If the advertisement distribution management apparatus 5 receives the detection information from the wireless LAN access point 3₁, the advertisement distribution management apparatus 5 associates the detection information with the advertising content and stores the detection information (step S5). Thereby, the wireless terminal 2 of a user who is likely to view the advertising content displayed on the digital signage 4 can be associated with the advertising content.

Then, if the user of the wireless terminal 2 moves to the attracting customer side store and enters the AP communication area 6₂, the wireless LAN access point 3₂ acquires the wireless signal from the wireless terminal 2 (step S6) and transmits the detection information including the information on the wireless terminal 2 to the advertisement distribution management apparatus 5 (step S7).

If the advertisement distribution management apparatus 5 receives the detection information from the wireless LAN access point 3₂, the advertisement distribution management apparatus 5 determines that the user of the wireless terminal 2 has been guided to the attracting customer side store by the advertising content and updates information on a result of remitting customer by the advertising content (step S8). For example, the advertisement distribution management apparatus 5 increments a remitting customers count value corresponding to the advertising content, whenever it is determined that the user has been guided to the attracting customer side store by the advertising content. Thereby, the number of users of the wireless terminals 2 guided to the attracting customer side store by the advertising content can be recognized.

If display of the advertising content on the digital signage 4 ends, the advertisement distribution management apparatus 5 determines advertisement charges of the aadvertising content (step S9). The advertisement charges are a price for the display of the advertising content on the digital signage 4 and the attracting customer side store side pays the advertisement charges to a service operator (hereinafter, referred to as an advertisement service operator) side of the advertising system 1. If the advertisement service operator acquires the advertisement charges from the attracting customer side store side, the advertisement service operator pays a part of the advertisement charges (for example, an amount of money of a constant ratio with respect to the advertisement charges) as affiliate charges to the remitting customer side store.

As such, when the advertising system 1 according to the first embodiment detects the wireless terminal 2 having entered the AP communication area 6₂ of the wireless LAN access point 3₂ arranged in the attracting customer side store after having entered the AP communication area 6₁ of the wireless LAN access point 3₁ arranged in the remitting customer side store, the advertising system 1 updates the information on the result of remitting customer by the advertising content. For this reason, the advertising effect of the advertising content displayed by the digital signage 4 can be determined quickly and appropriately.

When the wireless terminal 2 exists in a predetermined range of the front of the digital signage 4, which is highly likely to view the digital signage 4, in the AP communication area 6₁, the advertisement distribution management apparatus 5 may associate the wireless terminal 2 and the advertising content with each other. In this way, the advertising effect of the advertising content can be determined with higher precision. The advertisement distribution management apparatus 5 can determine whether the wireless terminal 2 has entered the predetermined range of the front of the digital signage 4, by a radio field intensity of the wireless signal of the wireless terminal 2 detected by the wireless LAN access point 3₁.

Hereinafter, content of a specific configuration and a specific process of the advertising system described above will be described with reference to the drawings.

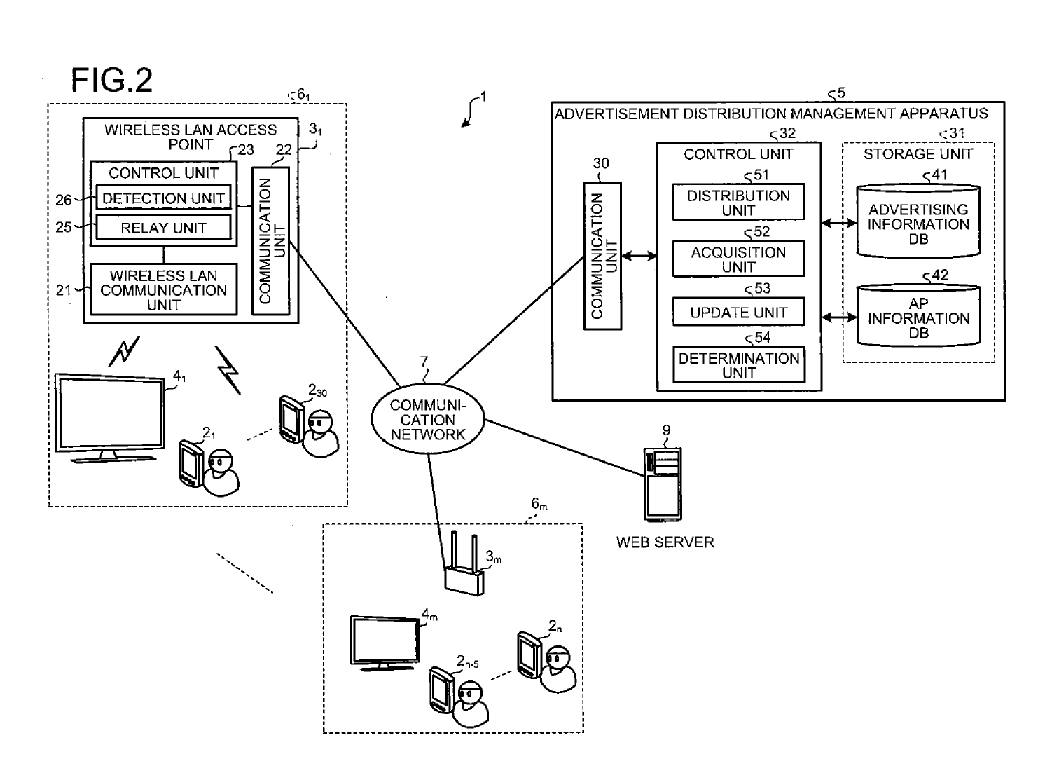

1.2. Specific example of advertising system 1 A specific example of the advertising system 1 according to the first embodiment will be described using FIG. 2. FIG. 2 is a diagram illustrating an example of a specific configuration of the advertising system 1 according to the first embodiment.

As illustrated in FIG. 2, the advertising system 1 has wireless LAN access points 3₁ to 3ₘ (hereinafter, generally referred to as wireless LAN access points 3), digital signages 4₁ to 4ₘ (hereinafter, generally referred to as digital signages 4), and an advertisement distribution management apparatus 5. The wireless LAN access point 3 and the advertisement distribution management apparatus 5 are connected to enable communication through the communication network 7. The communication network 7 is, for example, a wide area network (WAN) such as the Internet and a web server 9 is also connected to the communication network 7.

The wireless LAN access point 3 is provided to correspond to the arrangement place of the digital signage 4. In the example illustrated in FIG. 2, for example, the wireless LAN access point 3₁ is provided to correspond to the arrangement place of the digital signage 4₁ and the digital signage 4₁ is included in the AP communication area 6₁ of the wireless LAN access point 3₁. In addition, the wireless LAN access point 3ₘ is provided to correspond to the arrangement place of the digital signage 4ₘ and the digital signage 4ₘ is included in the AP communication area 6ₘ of the wireless LAN access point 3ₘ. The AP communication areas 6₁ to 6ₘ may be generally referred to as the AP communication areas 6 hereinafter.

In the example illustrated in FIG. 2, the digital signage 4 is arranged in the AP communication area 6 of each wireless LAN access point 3 and the wireless LAN access point 3 functions as a remitting customer side wireless LAN communication unit and an attracting customer side wireless LAN communication unit. However, the digital signage 4 may not be arranged in a part of the AP communication areas 6. In this case, the wireless LAN access point 3 in which the digital signage 4 is not arranged in the AP communication area 6 functions as an attracting customer side wireless LAN communication unit.

The digital signage 4 includes a display such as a liquid crystal display, a plasma display, and an organic EL display or a projector. The digital signage 4 has a wireless/wired. LAN communication function. For example, when the wireless LAN is used, the digital signage 4 can receive the advertising content from the advertisement distribution management apparatus 5 through the wireless LAN access point 3 and display the advertising content. In addition, when the wired LAN is used, the digital signage 4 can receive the advertising content from the advertisement distribution management apparatus 5 through the wireless LAN access point 3 or other network and display the advertising content. For example, when an area of the store to be the arrangement place of the digital signage 4 is large, a plurality of wireless LAN access points 3 can be arranged in one store.

Wireless terminals 2₁ to 2ₙ (hereinafter, generally referred to as wireless terminals 2) are terminal apparatuses that have a wireless LAN communication function mounted therein. For example, the wireless terminals 2₁ to 2ₙ are smart phones, tablet personal computers (PC), or game machines. The wireless terminal 2 can have access to the web server 9 through the wireless LAN access point 3, in the AP communication area 6 of the wireless LAN access point 3.

Hereinafter, the wireless LAN access point 3 and the advertisement distribution management apparatus 5 constituting the advertising system 1 will be described in detail.

1.3. Configuration of Wireless LAN Access Point 3

First, a configuration of the wireless LAN access point 3 will be specifically described. As illustrated in FIG. 2, the wireless LAN access point 3 has a wireless LAN communication unit 21, a communication unit 22, and a control unit 23.

The wireless LAN communication unit 21 is arranged such that a region including the arrangement place of the digital signage 4 becomes the AP communication area 6 thereof. The wireless LAN communication unit 21 is a communication interface to perform wireless LAN communication and exchanges information with the wireless terminal 2 having the wireless LAN communication function mounted therein. As the wireless LAN, for example, there is a wireless LAN defined by IEEE802.11. However, the wireless LAN is not limited to the wireless LAN of this standard.

The communication unit 22 is connected to the communication network 7 and exchanges information with a communication network side apparatus (for example, the advertisement distribution management apparatus 5 or the web server 9) through the communication network 7. The communication unit 22 is connected to the communication network 7 by wire or wireless.

The control unit 23 includes a relay unit 25 to execute an information relay process and a detection unit 26 to execute a detection process of the wireless terminal 2 and realizes or executes a function or an action of an information process to be described below. An internal configuration of the control unit 23 is not limited to the above configuration and may be any other configuration to execute the information process to be described below.

The relay unit 25 transmits the information acquired from the wireless terminal 2 through the wireless LAN communication unit 21 from the communication unit 22 to the communication network side apparatus and transmits the information acquired from the communication network side apparatus through the communication unit 22 from the wireless LAN communication unit 21 to the wireless terminal 2.

The transmission of the information from the wireless LAN access point 3 to the communication network side apparatus is performed by packet communication in which an address of the communication network 7 allocated to the wireless LAN access point 3 is set as a transmission origin address and an address of the communication network 7 allocated to the communication network side apparatus is set as a transmission destination address. The address of the communication network 7 is an address allocated to the communication unit 22 and is, for example, an IP address.

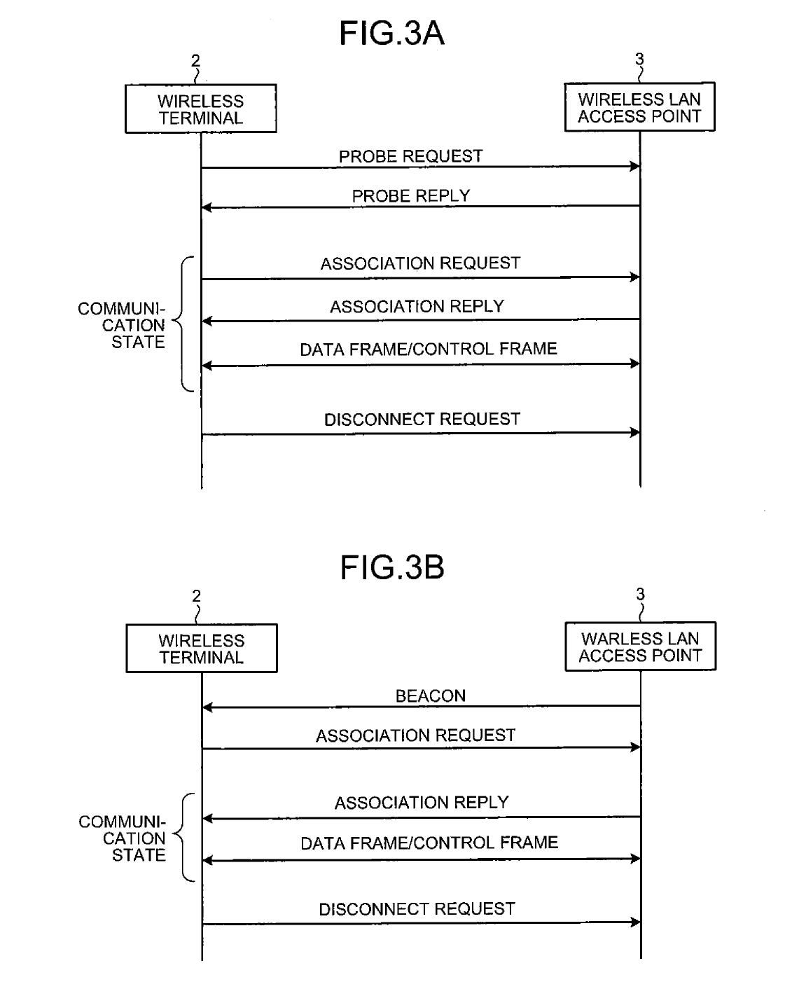

The detection unit 26 acquires a wireless packet transmitted from the wireless terminal 2 through the wireless LAN communication unit 21 and detects presence of the wireless terminal 2. FIGS. 3A and 3B are diagrams illustrating sequence examples of session establishment between the wireless LAN access point 3 and the wireless terminal 2.

In the example illustrated in FIG. 3A, a wireless packet called a probe request is transmitted periodically from the wireless terminal 2 by broadcasting and the detection unit 26 acquires the wireless packet through the wireless LAN communication unit 21 and detects presence of the wireless terminal 2.

A basic service set identifier (BSSID) is included in the probe request and the detection unit 26 transmits a probe reply to the wireless terminal 2, when the BSSID is matched with a BSSID of the wireless LAN communication unit 21. A state of the wireless terminal 2 that has received the probe reply changes to a communication state, when setting of automatic communication is given.

The change to the communication state is performed by establishing a session by an association request and an association reply, as illustrated in FIG. 3A. Then, a data frame or a control frame is exchanged between the wireless terminal 2 and the wireless LAN communication unit 21 and the state of the wireless terminal becomes the communication state.

In addition, as illustrated in FIG. 3B, the detection unit 26 broadcasts a wireless packet called a beacon to the wireless terminal 2 not transmitting the wireless packet periodically through the wireless LAN communication unit 21, receives an association request for the beacon, and detects presence of the wireless terminal 2. The detection unit 26 that has received the association request transmits an association reply to the wireless terminal 2 to establish a session and makes a state between the wireless terminal 2 and the wireless LAN communication unit 21 become the communication state.

If the state of the wireless terminal changes to the communication state, the detection unit 26 receives the wireless packet repetitively until the communication state is released and detects the presence of the wireless terminal 2. When a disconnect request is transmitted from the wireless terminal 2 or when the wireless packet cannot be exchanged between the wireless terminal 2 and the wireless LAN communication unit 21, the communication state is released.

When it is determined that the wireless terminal 2 has been detected, the detection unit 26 transmits detection information to the advertisement distribution management apparatus 5 through the communication unit 22. Specifically, the detection unit 26 extracts a terminal ID included the wireless packet transmitted from the wireless terminal 2 and detects a radio field intensity.

The terminal ID is, for example, a media access control address (MAC address) of the wireless LAN communication unit of the wireless terminal 2. The terminal ID is added to the wireless packet and is transmitted from the wireless terminal 2. In addition, the terminal ID may be identification information peculiar to the wireless terminal 2. For example, the terminal ID may be a hash value acquired by operating information on a URL of a website read by the wireless terminal 2 with a predetermined hash function.

The radio field intensity is a radio field intensity of a wireless signal received by the wireless LAN access point 3. The radio field intensity may be received signal strength indication (RSSI) acquired in the wireless terminal 2. In this case, a wireless signal including information on the radio field intensity is transmitted from the wireless terminal 2 to the wireless LAN access point 3.

The detection unit 26 transmits information including the terminal ID, the radio field intensity, a detection time, and an AP-ID of the wireless terminal 2 as detection information to the advertisement distribution management apparatus 5 periodically (for example, with a period of one second). As the AP-ID, for example, a network address of the communication network 7 allocated to the communication unit 22 can be used. In addition, the detection time is a time when the presence of the wireless terminal 2 has been detected. However, a time when the detection information is transmitted can be set as the detection time.

1.4. Configuration of Advertisement Distribution Management Apparatus 5

Next, a specific configuration of the advertisement distribution management apparatus 5 according to the embodiment will be described. As illustrated in FIG. 2, the advertisement distribution management apparatus 5 has a communication unit 30, a storage unit 31, and a control unit 32. The storage unit 31 has an advertising information DB 41 and an AP information DB 42 and the control unit 32 has a distribution unit 51, an acquisition unit 52, an update unit 53, and a determination unit 54.

The communication unit 30 is an interface such as a network interface card (NIC). The control unit 32 exchanges various information with the wireless LAN access point 3 through the communication unit 30 and the communication network 7 or exchanges various information with the wireless terminal 2 or the digital signage 4 through the wireless LAN access point 3.

Each of the advertising information DB 41 and the AP information DB 42 is a semiconductor memory element such as a random access memory (RAM) and a flash memory or a storage device such as an optical disk, and a hard disk. The advertising information DB 41 and the AP information DB 42 may be configured as one DB. In addition, various IDs stored in the advertising information DB 41 and the AP information DB 42 are described using codes such as “A1” or “D1”. However, the codes are codes denoted to distinguish the various IDs for convenience of explanation and the present invention is not limited to the codes.

The control unit 32 is realized by an integration circuit such as an application specific integrated circuit (ASIC) or a field programmable gate array (FPGA). In addition, a program stored in an internal storage device is executed by a central processing unit (CPU) or a micro processing unit (MPU) using the RAM as a work area and the control unit 32 functions as the distribution unit 51, the acquisition unit 52, the update unit 53, and the determination unit 54. A configuration of the control unit 32 is not limited to the above configuration and may be any other configuration to execute the information process to be described below.

1.4.1. Distribution Unit 51

The distribution unit 51 transmits the advertising content to the digital signage 4, on the basis of the DS information table stored in the advertising information DB 41. In the DS information table, a display schedule of the advertising content for each digital signage 4 is set.

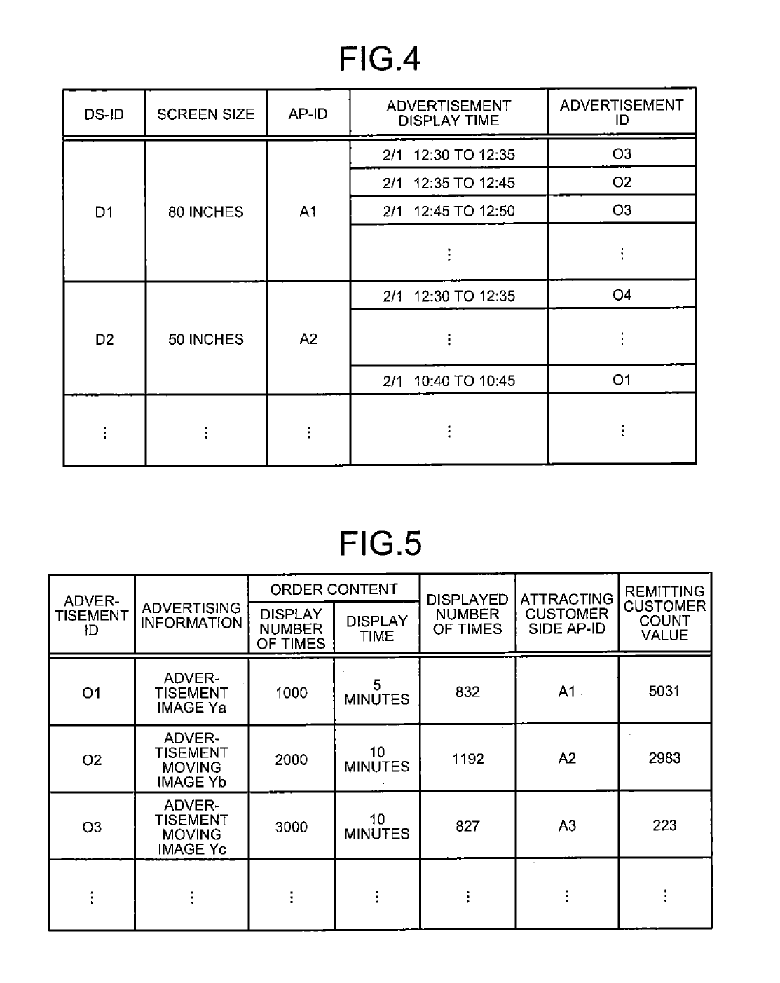

FIG. 4 is a diagram illustrating an example of the DS information table stored in the advertising information DB 41. As illustrated in FIG. 4, the DS information table is information in which a “screen size”, an “AP-ID”, an “advertisement display time”, and an “advertisement ID” are associated with each “DS-ID”.

The “DS-ID” is identification information of the digital signage 4. When the digital signage 4 is connected directly to the communication network 7, the network address of the communication network 7 allocated to the digital signage 4 can be used as the DS-ID.

The “screen size” is a size of an image that is displayed by the digital signage 4. For example, when the digital signage 4 is a display, the “screen size” is a screen size of the display and when the digital signage 4 is a projector, the “screen size” is a size of an image projected by the projector.

The “AP-ID” is identification information of the wireless LAN access point 3 arranged to correspond to the digital signage 4. For example, the “AP-ID” is the network address of the communication network 7 allocated to the communication unit 22 of the wireless LAN access point 3.

The “advertisement display time” is a time when the advertising content is displayed on the digital signage 4 and the “advertisement ID” is set to correspond to the advertisement display time. The “advertisement ID” is identification information of the advertising content. For example, a hash value acquired by inputting data of the advertising content to a predetermined hash function may be used as the advertisement ID.

In the example illustrated in FIG. 4, for example, in the digital signage 4 of a DS-ID “D1”, an advertisement ID “O3” is set to a time from 12:30 to 12:35 of February 1 and an advertisement ID “O2” is set to a time from 12:35 to 12:45.

The distribution unit 51 reads advertising content of the advertisement ID “O3” from the advertising information DB 41 before the time becomes 12:30 of February 1 and transmits the advertising content to the digital signage 4 of the DS-ID “D1” and reads advertising content of the advertisement ID “O2” from the advertising information DB 41 before the time becomes 12:35 and transmits the advertising content to the digital signage 4 of the DS-ID “D1”.

When the digital signage 4 is connected to the communication network 7 through the wireless LAN access point 3, the distribution unit 51 transmits advertising information including the DS-ID becoming the destination and the advertising content to the wireless LAN access point 3. Thereby, the advertising content is transmitted from the wireless LAN access point 3 to the digital signage 4. In addition, when the digital signage 4 is connected directly to the communication network 7, the distribution unit 51 transmits the DS-ID as the destination to the communication network 7. Thereby, the advertising content is transmitted to the digital signage 4.

The distribution unit 51 reads the advertising content from the advertising information DB 41, on the basis of the advertising information table. FIG. 5 is a diagram illustrating an example of the advertising information table stored in the advertising information DB 41. As illustrated in FIG. 5, the advertising information table is information in which “advertising information”, “order content”, the “displayed number of times”, an “attracting customer side AP-ID”, and a “remitting customer count value” are associated with each “advertisement ID”.

The “advertisement ID” is the same ID as the “advertisement ID” set in the DS information table. The “advertising information” is information on the advertising content to be displayed on the digital signage 4. As the advertising content, there are still image data, moving image data, and animation data. The advertising information set in the advertising information table is data of the advertising content. However, the advertising information may be information showing a storage position of the advertising content in the advertising information DB 41.

The “order content” is information showing a display condition of the advertising content set by the advertiser and a condition of the “display number of times” and a condition of the “display time” are set. The “display number of times” is the number of times of displaying the advertising content and the “display time” is a one-time display time of the advertising content. The “displayed number of times” is the number of times of having displayed the advertising content on the digital signage 4.

For example, in the advertising content of the advertisement ID “O1”, the display number of times is 1000, the display time is five minutes, and the displayed number of times is 832 as the order content. In addition, in the advertising content of the advertisement ID “O2”, the display number of times is 2000, the display time is 10 minutes, and the displayed number of times is 1192 as the order content.

The “attracting customer side AP-ID” is an AP-ID of the wireless LAN access point 3 that is arranged in a commercial space that is an advertisement target of the advertising content. For example, in the advertising content of the advertisement ID “O1”, the arrangement place of the wireless LAN access point 3 of the AP-ID “A1” is the advertisement target.

The “remitting customer count value” is information showing an advertising effect of the advertising content. When the remitting customer count value is large, this means that the advertising effect by the advertising content is high. The remitting customer count value is counted up by the update unit 53.

1.4.2. Acquisition Unit 52

The acquisition unit 52 acquires the detection information transmitted from the wireless LAN access point 3. If the acquisition unit 52 acquires the detection information from the wireless LAN access point 3, the acquisition unit 52 updates the detection information data of the AP information DB 42, on the basis of the terminal ID, the radio field intensity, the detection time, and the AP-ID included in the detection information.

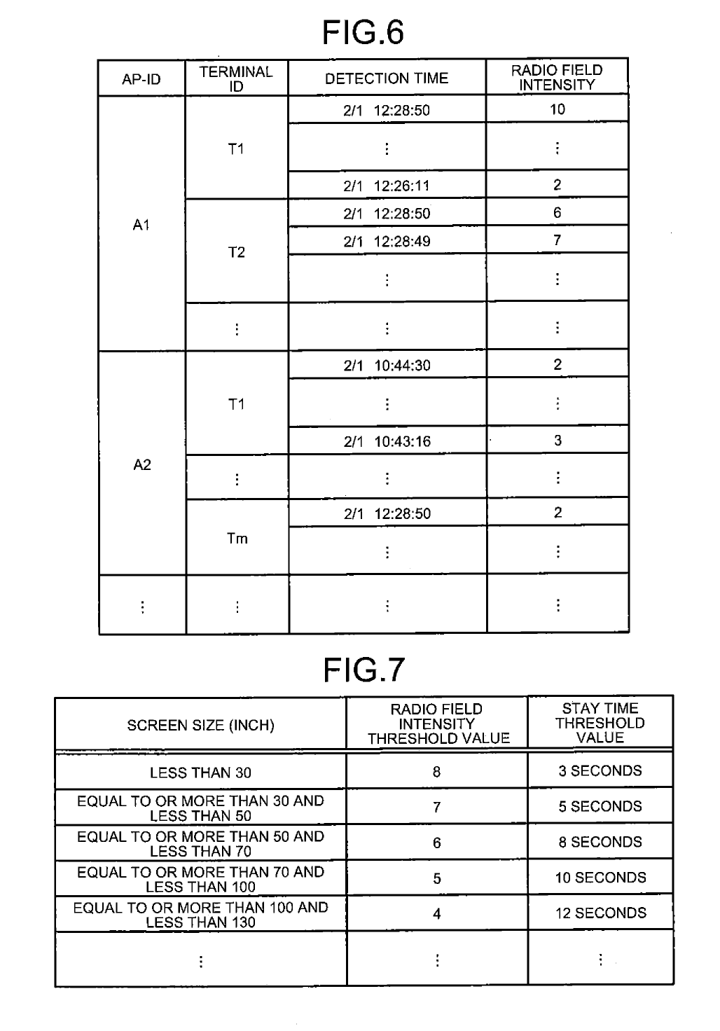

FIG. 6 is a diagram illustrating an example of the detection information data stored in the AP information DB 42. As illustrated in FIG. 6, the detection information data is information in which a “terminal ID”, a “detection time”, and “radio field intensity” are associated with each “AP-ID”.

The “AP-ID” is identification information of the wireless LAN access point 3 and is information allocated to each wireless LAN access point 3.

The “terminal ID” is a terminal ID of the wireless terminal 2 that exists in the AP communication area 6 of the associated wireless LAN access point 3. For example, in the example illustrated in FIG. 6, wireless terminals 2 of terminal IDs “T1” and “T2” exist in the AP communication area 6 of the wireless LAN access point 3 of the AP-ID “A1”.

The “radio field intensity” is information on the radio field intensity of the wireless terminal 2 that exists in the AP communication area 6. As illustrated in FIG. 6, information on the radio field intensity for each detection time is set in the detection information data. In the example illustrated in FIG. 6, the radio field intensity is represented by a strength level of which a value increases when the strength increases in a range of 0 to 10. However, the radio field intensity may be set in other units (for example, dBm).

1.4.3. Update Unit 53

The update unit 53 detects the wireless terminal 2 having entered the attracting customer side communication area after having entered the remitting customer side communication area, on the basis of the detection information data, the DS information table, and the advertising information table, and updates the remitting customer count value.

Specifically, the update unit 53 detects the wireless terminal 2 having entered the remitting customer side communication area, on the basis of the detection information data and the DS information table. The remitting customer side communication area is the AP communication area 6 of the wireless LAN access point 3 associated with the digital signage 4 of the advertising content.

In addition, the update unit 53 detects the wireless terminal 2 having entered the attracting customer side communication area, on the basis of the detection information data and the advertising information table. The attracting customer side communication area is the AP communication area 6 of the wireless LAN access point 3 that is arranged in the commercial space becoming the advertisement target of the advertising content.

In addition, the update unit 53 detects the wireless terminal 2 (hereinafter, referred to as a remitting customer determination candidate terminal) having entered the attracting customer side communication area after having entered the remitting customer side communication area, in an advertising content unit. The update unit 53 determines whether the detected remitting customer determination candidate terminal satisfies the count condition set in the count determination table and updates the remitting customer count value in an advertising content unit, according to a determination result.

FIG. 7 is a diagram illustrating an example of the count determination table stored in the advertising information DB 41. As illustrated in FIG. 7, the count determination table is information in which a “radio field intensity threshold value” and a “stay time threshold value” are associated with each “screen size”.

The “screen size” is a screen size of the digital signage 4. The “radio field intensity threshold value” is a threshold value of the radio field intensity of a wireless signal from the wireless terminal 2, which is received by the wireless LAN access point 3 of the remitting customer side, and the “stay time threshold value” is a threshold value of a stay time of the wireless terminal 2 in the remitting customer side communication area.

The update unit 53 reads a count condition corresponding to the screen size of the digital signage 4 of the remitting customer side from the count determination table and increments a count value corresponding to the advertising content, when the radio field intensity or the stay time of the remitting customer determination candidate terminal in the remitting customer side communication area satisfies the count condition.

Here, it is assumed that the DS information table is in a state illustrated in FIG. 4, the advertising information table is in a state illustrated in FIG. 5, and the detection information table is in a state illustrated in FIG. 6. In this case, the update unit 53 performs the update of the remitting customer count value regarding the advertising content of the advertisement ID “O1” as follows.

As illustrated in the DS information table of FIG. 4, the advertising content of the advertisement ID “O1” is displayed on the digital signage 4 of the DS-ID “D2”, during a period from 10:40 to 10:45 of February 1. Therefore, the update unit 53 determines that the AP communication area 6 corresponding to the AP-ID “A2” is the remitting customer side communication area corresponding to the advertisement ID “O1”, during the period from 10:40 to 10:45 of February 1.

In addition, as illustrated in the advertising information table of FIG. 5, the advertisement ID “O1” corresponds to the attracting customer side AP-ID “A1” and an advertisement target of the advertising content of the advertisement ID “O1” is a commercial space of the wireless LAN access point 3 of the AP-ID “A1”. Therefore, the update unit 53 determines that the AP communication area 6 corresponding to the AP-ID “A1” is the attracting customer side communication area corresponding to the advertisement ID “O1”.

As illustrated in the detection information table of FIG. 6, the wireless terminal 2₁ of the terminal ID “T1” enters the AP communication area of the wireless LAN access point 3 of the AP-ID “A2” during a period from 10:43:16 to 10:44:30 of February 1. Therefore, the update unit 53 determines that the wireless terminal 2₁ of the terminal ID “T1” has entered the remitting customer side communication area corresponding to the advertisement ID “O1”.

In addition, as illustrated in the detection information table of FIG. 6, the wireless terminal 2₁ of the terminal ID “T1” enters the AP communication area 6 of the wireless LAN access point 3 of the AP-ID “A1” at 12:26:11 of February 1. Therefore, the update unit 53 determines that the wireless terminal 2₁ of the terminal ID “T1” has entered the attracting customer side communication area corresponding to the advertisement ID “O1”.

Because the wireless terminal 2₁ of the terminal ID “T1” enters the attracting customer side communication area after entering the remitting customer side communication area, the update unit 53 determines that the wireless terminal 2₁ of the terminal ID “T1” is the remitting customer determination candidate terminal with respect to the advertising content of the advertisement ID “O1”.

Next, the update unit 53 determines whether the detected remitting customer determination candidate terminal satisfies the count condition set in the count determination table and updates the remitting customer count value in an advertising content unit, according to a determination result. During a period of from 10:40 to 10:45 of February 1, the digital signage 4 that has displayed the advertising content of the advertisement ID “O1” is the digital signage 4 of the DS-ID “D2”. In addition, as illustrated in FIG. 4, a screen size of the digital signage 4 of the DS-ID “D2” is 50 inches.

In the count determination table illustrated in FIG. 7, because 50 inches are included in a range from equal to or more than 50 inches to less than 70 inches, the update unit 53 determines that the radio field intensity threshold value is “6” and the stay time threshold value is “8 seconds”. Therefore, the update unit 53 determines whether a state in which the radio field intensity of the remitting customer determination candidate terminal is six or more is continuously maintained for eight seconds or more, in the remitting customer side communication area, on the basis of the detection information table.

When the state in which the radio field intensity of the remitting customer determination candidate terminal is six or more is continuously maintained for eight seconds or more, in the remitting customer side communication area, the update unit 53 increments the “remitting customer count value” corresponding to the advertisement ID “O1” by “1”, in the advertising information table.

In the example illustrated in FIG. 5, for example, with respect to the advertisement ID “O1”, the number of times of having detected the wireless terminal 2, which has entered the AP communication area 6 of the wireless LAN access point 3 of the attracting customer side after having entered the AP communication area 6 of the wireless LAN access point 3 of the remitting customer side, is 5031.

As such, the update unit 53 detects the wireless terminal 2 having entered the attracting customer side communication area after having entered the remitting customer side communication area and updates the remitting customer count value. It can be estimated that a user of the wireless terminal 2 that has entered the attracting customer side communication area after having entered the remitting customer side communication area in which the advertising content is displayed is guided to the attracting customer side communication area by the advertising content. Therefore, an advertising effect by the advertising content can be determined quickly and appropriately, on the basis of the remitting customer count value.

In addition, because the radio field intensity threshold value or the stay time threshold value is changed by the screen size of the digital signage 4, the advertising effect by the advertising content can be determined with higher precision by setting the wireless terminal 2, which is highly likely to view the digital signage 4, as an update target of the remitting customer count value. The update unit 53 does not set both the radio field intensity threshold value and the stay time threshold value as an update condition of the remitting customer count value and can set any one of the radio field intensity threshold value and the stay time threshold value as the update condition. In addition, only a surrounding portion of the digital signage 4 may be set as the AP communication area, by adjusting the AP communication area of the wireless LAN access point 3 of the remitting customer side. In this case, the radio field intensity threshold value and the stay time threshold value may not be used.

In addition, the update unit 53 can change the radio field intensity threshold value or the stay time threshold value according to whether audio information is included in the advertising content. When the audio information is included in the advertising content, the digital signage 4 outputs audio (music or a voice) corresponding to the audio information from a speaker provided inside.

For example, when the audio information is included in the advertising content, the update unit 53 can set a new threshold value, which is acquired by multiplying any one of the radio field intensity threshold value and the stay time threshold value set in the count determination table or both the radio field intensity threshold value and the stay time threshold value with a predetermined coefficient Ka (<1), as the count condition. In addition, when the audio information is not included in the advertising content, the update unit 53 can set a new threshold value, which is acquired by multiplying any one of the radio field intensity threshold value and the stay time threshold value set in the count determination table or both the radio field intensity threshold value and the stay time threshold value with a predetermined coefficient Kb (>1), as the count condition.

The update unit 53 can change any one of the radio field intensity threshold value and the stay time threshold value or both the radio field intensity threshold value and the stay time threshold value, according to a kind, an audio volume, and a frequency of the audio information included in the advertising content.

In addition, the update unit 53 can update the remitting customer count value, only when the radio field intensity or the stay time of the wireless terminal 2 having entered the attracting customer side communication area is the predetermined threshold value or more. In this way, a user of the wireless terminal 2 who is highly likely to purchase commodities or services in the commercial space of the attracting customer side communication area can be extracted and an advertising effect by the advertising content can be determined with higher precision. In this case, the update unit 53 can update the remitting customer count value, when any one of the radio field intensity and the stay time of the wireless terminal 2 having entered the attracting customer side communication area is the predetermined threshold value or more.

In addition, the update unit 53 can set a plurality of kinds of remitting customer count values to each advertising content, in the advertising information table. For example, the update unit 53 divides the radio field intensity threshold value or the stay time threshold value into a plurality of steps and updates a remitting customer count value corresponding to each step, on the basis of a count value of each step. For example, the update unit 53 updates a first remitting customer count value when the radio field intensity threshold value or the stay time threshold value is equal to or more than a first threshold value and less than a second threshold value and updates a second remitting customer count value when the radio field intensity threshold value or the stay time threshold value is equal to or more than a second threshold value. As such, the plurality of remitting customer count values are set, so that a remitting customer effect based on a state of the wireless terminal 2 in the remitting customer side communication area can be updated and an advertising effect by the advertising content can be determined more appropriately.

1.4.4. Determination Unit 54

The determination unit 54 determines advertisement charges to be a value of a price for the display of the advertising content on the digital signage 4, in an advertising content unit. Specifically, when the display of the advertising content on the digital signage 4 has ended, the determination unit 54 determines the advertisement charges of the advertising content, on the basis of the remitting customer count value set in the advertising information table.

The determination unit 54 determines the advertisement charges of the advertising content by any one of a first determination mode and a second determination mode. The determination mode is set for each advertising content. The determination mode for each advertising content is set by selection of the advertiser, for example.

The determination unit 54 sets a result obtained by multiplying the remitting customer count value with a predetermined value as the advertisement charges, with respect to the advertising content to which the first determination mode is set. For example, with respect to advertising content of an advertisement ID “O1”, when the remitting customer count value is 10000 and the predetermined value is 10, the determination unit 54 determines advertisement charges of the advertising content of the advertisement ID “O1” as one hundred thousand yen (=10000×10).

The determination unit 54 sets an addition value of a value obtained by multiplying the remitting customer count value with a predetermined value and a value obtained by multiplying a multiplication value of the display number of times and the display time with a coefficient K as advertisement charges, with respect to the advertising content to which the second determination mode is set. For example, with respect to the advertising content of the advertisement ID “O1”, the remitting customer count value is set as 10000, the predetermined value is set as 5, and the coefficient K is set as 10. In this case, the determination unit 54 determines advertisement charges of the advertising content of the advertisement ID “O1” as one hundred thousand yen (=10000×5+1000>5×10).

After determining the advertisement charges of the advertising content, the determination unit 54 can transmit settlement information to which information on the determined advertisement charges is set to a settlement server (not illustrated in the drawings) and execute a settlement process.

1.5. Process Flow of Advertising System 1

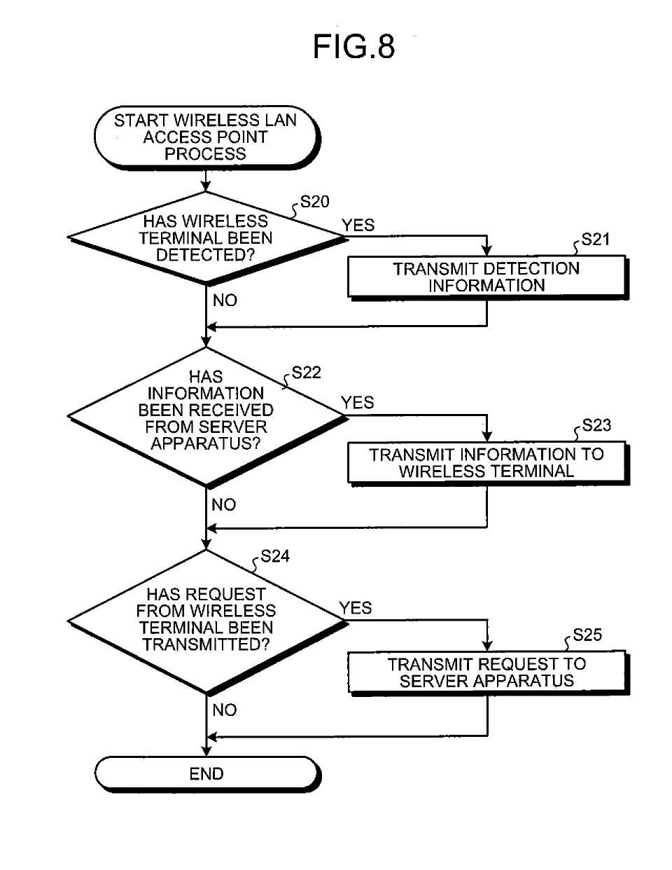

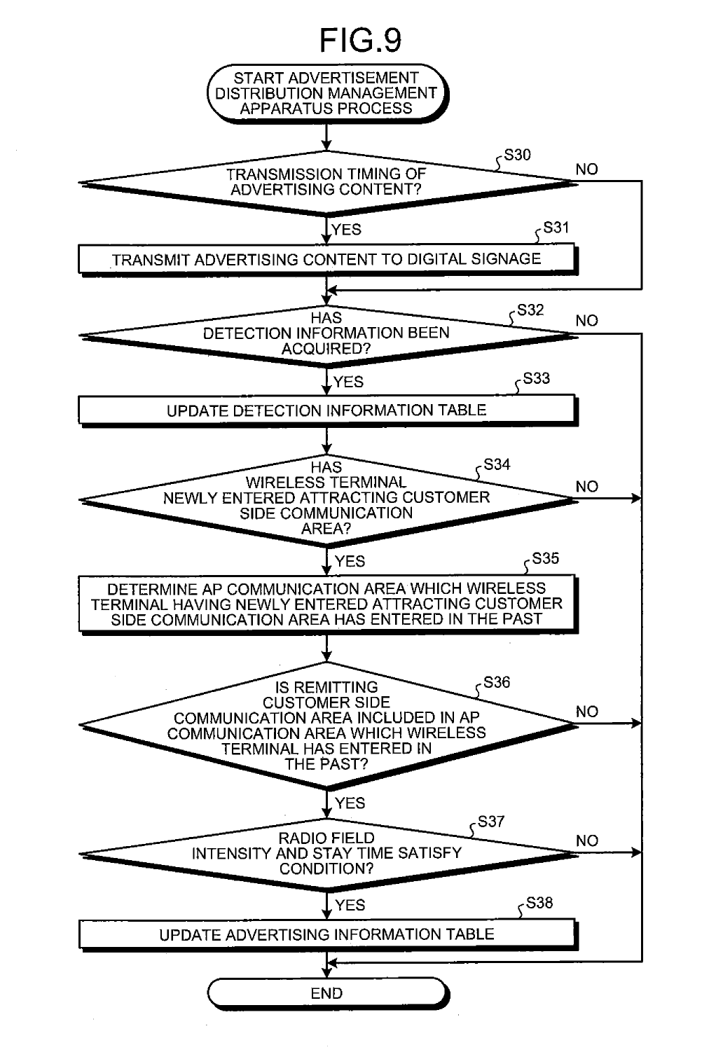

Next, a sequence of an information process by the advertising system 1 according to the embodiment will be described with reference to FIGS. 8 and 9.

1.5.1. Process Flow of Wireless LAN Access Point 3

First, the information process of the wireless LAN access point 3 according to the embodiment will be described with reference to FIG. 8. FIG. 8 is a flowchart of the information process in the wireless LAN access point 3. This operation is a process executed repetitively by the control unit 23 of the wireless LAN access point 3.

As illustrated in FIG. 8, the control unit 23 of the wireless LAN access point 3 determines whether the wireless terminal 2 has been detected through the wireless LAN communication unit 21 (step S20). In this process, when it is determined that the wireless terminal 2 has been detected (step S20; Yes), the control unit 23 transmits detection information including the terminal ID of the wireless terminal 2 or the AP-ID to the advertisement distribution management apparatus 5 through the communication unit 22 (step S21).

When it is determined that the wireless terminal 2 has not been detected (step S20; No) or when the process of step S21 has ended, the control unit 23 determines whether the information has been received from a server apparatus (for example, the web server 9) connected to the communication network 7 through the communication unit 22 (step S22). When it is determined that the information has been received from the server apparatus (step S22; Yes), the control unit 23 transmits the received information to the wireless terminal 2 becoming the destination of the information (step S23).

When it is determined that the information has not been received (step S22; No) or when the process of step S23 has ended, the control unit 23 determines whether a request for the server apparatus has been transmitted from the wireless terminal 2 (step S24). When it is determined that the request for the server apparatus has been transmitted from the wireless terminal 2 (step S24; Yes), the control unit 23 transmits the request for the server apparatus from the wireless terminal 2 to the server apparatus through the communication unit 22 (step S25).

When it is determined that the request for the server apparatus has not been transmitted from the wireless terminal 2 (step S24; No) or when the process of step S25 has ended, the control unit 23 ends the information process.

1.5.2. Process Flow of Advertisement Distribution Management Apparatus 5

Next, a process of the advertisement distribution management apparatus 5 will be described. FIG. 9 is a flowchart of the information process in the advertisement distribution management apparatus 5. This operation is a process executed repetitively by the control unit 32 of the advertisement distribution management apparatus 5.

As illustrated in FIG. 9, the control unit 32 determines whether transmission timing of the advertising content to the digital signage 4 has come, on the basis of the DS information table (step S30). When it is determined that the transmission timing has come (step S30; Yes), the control unit 32 reads the advertising content of which the transmission timing has come from the advertising information DB 41 and transmits the advertising content to the digital signage 4 through the communication network 7 (step S31).

When it is determined that the transmission timing has not come (step S30; No) or when the process of step S31 has ended, the control unit 32 determines whether the detection information from the wireless LAN access point 3 has been acquired through the communication unit 30 (step S32). When the detection information has been acquired (step S32; Yes), the control unit 32 updates the detection information table (step S33).

When the process of step S33 has ended, the control unit 32 determines whether the wireless terminal 2 has newly entered the attracting customer side communication area (step S34). When it is determined that the wireless terminal 2 has newly entered the attracting customer side communication area (step S34; Yes), the control unit 32 determines the AP communication area 6 which the wireless terminal 2 having newly entered the attracting customer side communication area has entered in the past (step S35).

In addition, the control unit 32 determines whether the remitting customer side communication area is included in the AP communication area 6 which the wireless terminal 2 having newly entered the attracting customer side communication area has entered in the past (step S36). When it is determined that the remitting customer side communication area is included in the AP communication area 6 (step S36; Yes), the control unit 32 sets the wireless terminal 2 having newly entered the attracting customer side communication area as a remitting customer target candidate terminal. In addition, the control unit 32 determines whether the radio field intensity and the stay time of the remitting customer target candidate terminal in the remitting customer side communication area satisfy the count condition set in the count determination table (step S37).

When it is determined that the radio field intensity and the stay time of the remitting customer target candidate terminal satisfy the count condition (step S37; Yes), the control unit 32 increments the remitting customer count value corresponding to the remitting customer target candidate terminal in the advertising information table and updates the advertising information table (step S38).

When it is determined that the detection information has not been acquired (step S32; No), when it is determined that the wireless terminal 2 has not newly entered the attracting customer side communication area (step S34; No), when it is determined that the remitting customer side communication area is not included in the AP communication area 6 (step S36: No), when it is determined in step S37 that the radio field intensity and the stay time of the remitting customer target candidate terminal do not satisfy the count condition (step S37; No), or when the process of step S38 has ended, the control unit 32 ends the information process.

As described above, the advertising system 1 according to the first embodiment detects the wireless terminal 2 having entered the attracting customer side communication area after having entered the remitting customer side communication area, on the basis of the information detected by the wireless LAN access point 3, and updates the information on the result of remitting customer by the advertising content, on the basis of the detection result. Thereby, an advertising effect by the advertising content can be determined quickly and appropriately.

### 2. Second Embodiment

2.1. Configuration of Advertising System

Next, an advertising system according to a second embodiment will be described. In the advertising system according to the second embodiment, an advertisement ID is transmitted from a wireless LAN access point to a wireless terminal in a remitting customer side communication area and the advertisement ID is acquired from the wireless terminal in an attracting customer side communication area, so that information on a result of remitting customer by advertising content is updated. Hereinafter, portions having the same functions as the configuration of the advertising system 1 according to the first embodiment are denoted with the same reference numerals and explanation thereof is omitted.

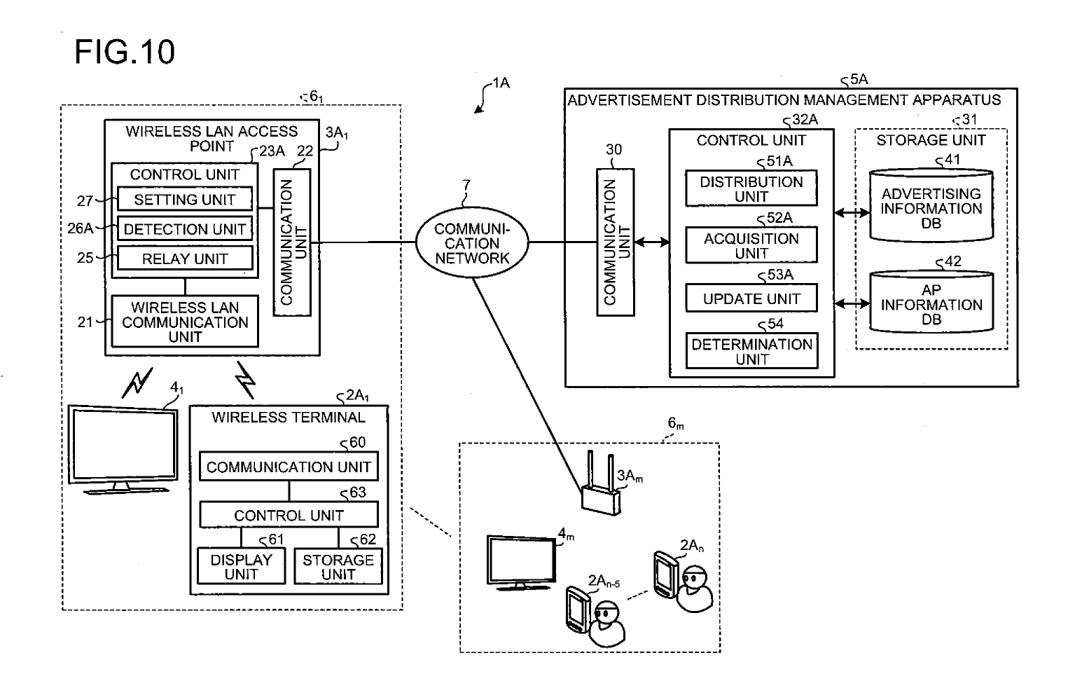

FIG. 10 is a diagram illustrating a configuration of the advertising system according to the second embodiment. As illustrated in FIG. 10, an advertising system 1A according to the second embodiment includes wireless terminals 2A₁ to 2Aₙ (hereinafter, generally referred to as wireless terminals 2A), wireless LAN access points 3A₁ to 3Aₘ (hereinafter, generally referred to as wireless LAN access points 3A), digital signages 4₁ to 4ₘ, and an advertisement distribution management apparatus 5A.

The wireless terminal 2A has a communication unit 60, a display unit 61, a storage unit 62, and a control unit 63. The communication unit 60 has a wireless LAN communication function and exchanges information with the wireless LAN access point 3A.

The storage unit 62 is a semiconductor memory element such as a RAM and a flash memory or a storage device such as a hard disk and an optical disk. The storage unit 62 stores various programs or setting data. The programs that are stored in the storage unit 62 are, for example, an OS and a dedicated application program (hereinafter, referred to as a dedicated application) acquired from the advertisement distribution management apparatus 5A.

The control unit 63 is realized by an integration circuit such as an ASIC or an FPGA. In addition, a program stored in the storage unit 62 is executed by a CPU or an MPU using an internal RAM not illustrated in the drawings as a work area and the control unit 63 realizes or executes a function or an action of an information process to be described below.

The control unit 63 acquires advertisement association information transmitted periodically (for example, with a period of one second) from the wireless LAN access point 3A of a remitting customer side communication area through the communication unit 60 and stores the advertisement association information in the storage unit 62. In addition, the control unit 63 detects radio field intensity of a wireless signal including the advertisement association information, associates the radio field intensity with the advertisement association information, and stores the radio field intensity in the storage unit 62. In the advertisement association information transmitted from the wireless LAN access point 3A, an advertisement ID, an attracting customer side AP-ID, and time information are included.

In addition, when the wireless terminal has entered the attracting customer side communication area, the control unit 63 transmits terminal information which the radio field intensity is added to the advertisement association information stored in the storage unit 62, to the wireless LAN access point 3A through the communication unit 60. The wireless LAN access point 3A of the attracting customer side communication area transmits the AP-ID of the own apparatus and the advertisement association information to the wireless terminal 2A when there is a corresponding digital signage 4 and transmits the AP-ID of the own apparatus to the wireless terminal 2A when there is not the corresponding digital signage 4. The control unit 63 determines that the wireless terminal has entered the attracting customer side communication area, when the AP-ID transmitted from the wireless LAN access point 3A is matched with the attracting customer side AP-ID included in the advertisement association information stored in the storage unit 62.

The wireless LAN access point 3A may transmit a wireless signal including an AP-LID of the own apparatus to the wireless terminal 2A, instead of the AP-ID of the own apparatus. The AP-LID is, for example, an MAC address of the wireless LAN communication unit 21 of the wireless LAN access point 3A.

The wireless LAN access point 3A has a wireless LAN communication unit 21, a communication unit 22, and a control unit 23A. The control unit 23A includes a relay unit 25, a detection unit 26A, and a setting unit 27.

The detection unit 26A acquires the terminal information transmitted from the wireless terminal 2A through the wireless LAN communication unit 21 and transmits the terminal information to the advertisement distribution management apparatus 5A.

The setting unit 27 acquires information (hereinafter, referred to as display advertisement information) including the advertisement ID, the attracting customer side AP-ID, and the advertisement display time of the advertising content displayed by the digital signage 4 from the advertisement distribution management apparatus 5A and stores the information inside. The setting unit 27 determines the advertising content displayed by the digital signage 4, on the basis of the advertisement display time of the display advertisement information, and makes the advertisement association information including the advertisement ID and the attracting customer side AP-ID of the advertising content transmit periodically from the wireless LAN communication unit 21. Thereby, the advertisement association information can be transmitted to the wireless terminal 2A having entered the attracting customer side AP communication area. In addition, the setting unit 27 may add the advertisement association information to a beacon or a probe reply and transmit the advertisement association information from the wireless LAN communication unit 21.

The advertisement distribution management apparatus 5A includes a communication unit 30, a storage unit 31, and a control unit 32A. The control unit 32A includes a distribution unit 51A, an acquisition unit 52A, an update unit 53A, and a determination unit 54.

Similar to the distribution unit 51, the distribution unit 51A transmits the advertising content to the digital signage 4, on the basis of the DS information table stored in the advertising information DB 41. In addition, the distribution unit 51A extracts the advertisement ID and the advertisement display time of the advertising content displayed on the digital signage 4 on the basis of the DS information table and extracts the attracting customer side AP-ID corresponding to the advertisement ID of the advertising content displayed on the digital signage 4 on the basis of the advertising information table. In addition, the distribution unit 51A transmits the display advertisement information including the extracted advertisement ID, advertisement display time, and attracting customer side AP-ID to the wireless LAN access point 3A corresponding to the digital signage 4.

For example, when the DS information table is in a state illustrated in FIG. 4, in the digital signage 4 of a DS-ID “D1”, advertising content of an advertisement ID “O2” is displayed during a period from 12:35 to 12:45 of February 1. In this case, the distribution unit 51A extracts information on the advertisement ID “O2” and information on the advertisement display time “12:35 to 12:45 of February 1”, with respect to the wireless LAN access point 3A of an AP-ID “A1” corresponding to the DS-ID “D1”.

In addition, when the advertising information table is in a state illustrated in FIG. 5, an attracting customer side AP-ID “A2” corresponds to the advertisement ID “O2” and the distribution unit 51A extracts the attracting customer side AP-ID “A2”. The distribution unit 51A transmits display advertisement information including the extracted advertisement ID “O2”, advertisement display time “12:35 to 12:45 of February 1”, and attracting customer side AP-ID “A2” to the wireless LAN access point 3A of the AP-ID “A1”.

The acquisition unit 52A acquires the terminal information transmitted from the wireless LAN access point 3A. When the acquisition unit 52A acquires the terminal information transmitted from the wireless LAN access point 3A, the acquisition unit 52A stores the terminal information in the AP information DB 42.

The update unit 53A detects the wireless terminal 2A having entered the attracting customer side communication area after having entered the remitting customer side communication area, on the basis of the terminal information stored in the AP information DB 42, and updates a remitting customer count value.

The terminal information is transmitted from the wireless terminal 2A having entered the attracting customer side communication area after having entered the remitting customer side communication area and the wireless terminal 2A that has transmitted the terminal information is a remitting customer determination candidate terminal. The update unit 53A determines whether the radio field intensity or the stay time of the remitting customer determination candidate terminal in the remitting customer side communication area satisfies a count condition set in the count determination table (refer to FIG. 7), on the basis of the terminal information transmitted from the remitting customer determination candidate terminal.

In this process, the update unit 53A reads a count condition corresponding to a screen size of the digital signage 4 arranged in the remitting customer side communication area from the count determination table. In addition, the update unit 53A determines whether the radio field intensity or the stay time of the remitting customer determination candidate terminal in the remitting customer side communication area satisfies the count condition, on the basis of the radio field intensity or the time information included in the terminal information transmitted from the remitting customer determination candidate terminal, by the same process as the process of the update unit 53. The update unit 53A increments the count value corresponding to the advertising content, when the radio field intensity or the stay time of the remitting customer determination candidate terminal in the remitting customer side communication area satisfies the count condition.

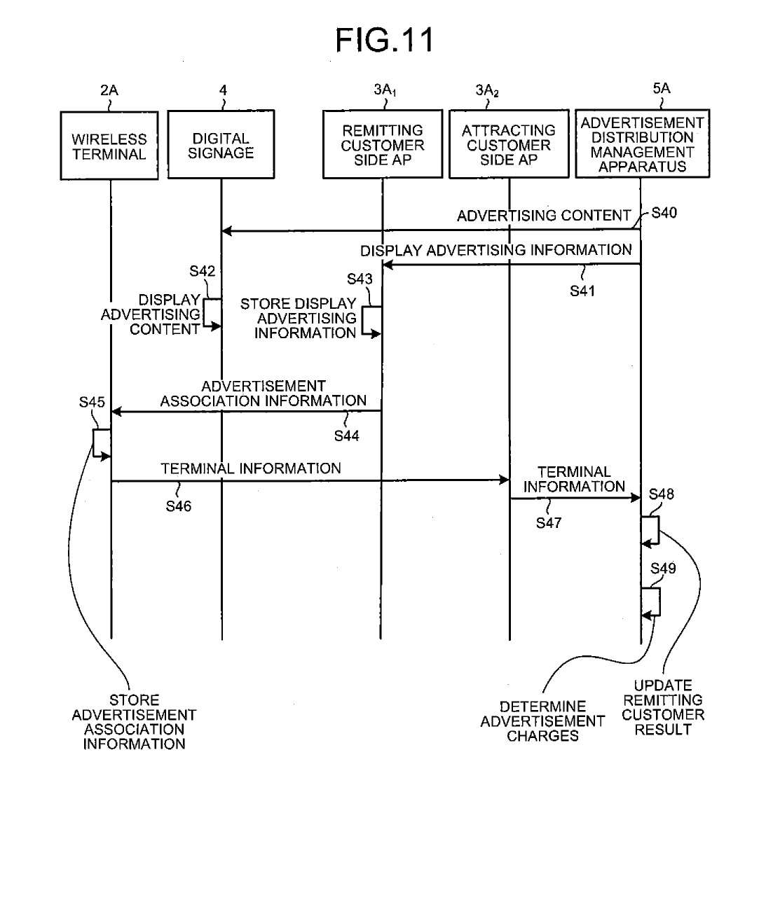

FIG. 11 is a diagram illustrating an advertising effect determination method by the advertising system 1A according to the second embodiment. As illustrated in FIG. 11, the advertisement distribution management apparatus 5A transmits the advertising content to the digital signage 4 arranged in the AP communication area 6₁ of the wireless LAN access point 3A₁ arranged in a remitting customer side store (step S40). The advertising content that is transmitted to the digital signage 4 is information that includes an advertisement regarding an attracting customer side store where the wireless LAN access point 3A₂ is arranged.

The advertisement distribution management apparatus 5A transmits display advertisement information including the information on the advertisement ID, the advertisement display time, and the attracting customer side AP-ID of the advertising content transmitted to the digital signage 4 to the wireless LAN access point 3A₁ arranged in the remitting customer side store (step S41).

If the digital signage 4 acquires the advertising content from the advertisement distribution management apparatus 5A, the digital signage 4 displays the advertising content (step S42). In addition, if the wireless LAN access point 3A₁ acquires the display advertisement information from the advertisement distribution management apparatus 5A, the wireless LAN access point 3A₁ stores the information on the display advertisement information in an internal storage unit (step S43).

The wireless LAN access point 3A₁ outputs the advertisement association information including the advertisement ID and the advertisement display time periodically from the wireless LAN communication unit 21, on the basis of the display advertisement information, in a state in which the advertising content is displayed on the digital signage 4 (step S44). Thereby, if the wireless terminal 2A enters the AP communication area 6₁, the wireless terminal can acquire the advertisement association information.

If the wireless terminal 2A receives the advertisement association information from the wireless LAN access point 3A₁, the wireless terminal 2A stores the advertisement association information (step S45). Thereby, the wireless terminal 2A can store information including the advertisement ID of the advertising content displayed on the digital signage 4 in the remitting customer side communication area.

Then, if a user of the wireless terminal 2A moves to the attracting customer side store and enters the AP communication area 6₂, the wireless LAN access point 3A₂ acquires terminal information from the wireless terminal 2A (step S46) and transmits the acquired terminal information to the advertisement distribution management apparatus 5A (step S47).

If the advertisement distribution management apparatus 5A receives the terminal information from the wireless LAN access point 3A₂, the advertisement distribution management apparatus 5A determines that the user of the wireless terminal 2A has been guided to the attracting customer side store by the advertising content and updates information on a result of remitting customer by the advertising content (step S48). For example, the advertisement distribution management apparatus 5A increments a remitting customer count value corresponding to the advertising content, whenever it is determined that the user has been guided to the attracting customer side store by the advertising content. Then, when the display of the advertising content to the digital signage 4 ends, the advertisement distribution management apparatus 5A determines advertisement charges of the advertising content, similarly to the process of step S9 illustrated in FIG. 1B, (step S49).

As such, in the advertising system 1A according to the second embodiment, the wireless terminal 2A acquires the advertisement association information including the advertisement ID and the attracting customer side AP-ID of the advertising content displayed by the digital signage 4 in the remitting customer side communication area which the wireless terminal 2A has entered and stores the advertisement association information, differently from the advertising system 1 according to the first embodiment. Thereby, it is not necessary to acquire the detection information and manage the detection information by the advertisement distribution management apparatus 5A and processing load of the advertisement distribution management apparatus 5A can be alleviated.

2.2. Process Flow of Advertising System 1

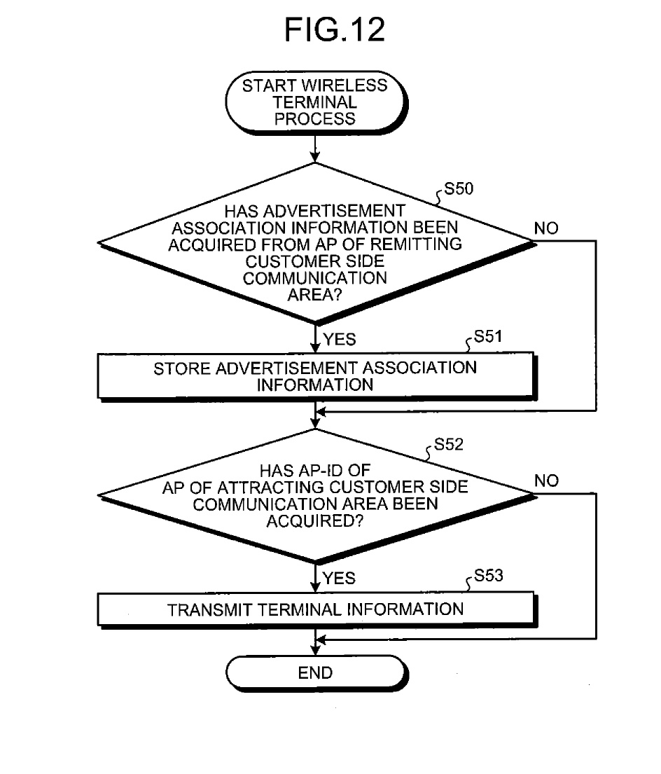

Next, a sequence of an information process by the advertising system 1A according to the second embodiment will be described with reference to FIGS. 12 to 14.

First, the information process of the wireless terminal 2A will be described with reference to FIG. 12. FIG. 12 is a flowchart of the information process in the wireless terminal 2A. This operation is a process executed repetitively by the control unit 63 of the wireless terminal 2A and is a process by a dedicated application.

As illustrated in FIG. 12, the control unit 63 of the wireless terminal 2A determines whether the advertisement association information has been acquired from the wireless LAN access point (AP) 3A of the remitting customer side communication area (step S50). In this process, when it is determined that the advertisement association information has been acquired (step S50; Yes), the control unit 63 stores the acquired advertisement association information in the storage unit 62 (step S51).

When it is determined that the advertisement association information has not been acquired (step S50; No) or when the process of step S51 has ended, the control unit 63 determines whether the AP-ID of the wireless LAN access point 3A of the attracting customer side communication area has been acquired (step S52). When it is determined that the AP-ID of the wireless LAN access point 3A of the attracting customer side communication area has been acquired (step S52; Yes), the control unit 63 transmits the information including the advertisement association information acquired from the wireless LAN access point 3A of the remitting customer side communication area as the terminal information to the wireless LAN access point 3A (step S53).

When it is determined that the AP-ID of the wireless LAN access point 3A of the remitting customer side communication area has not been acquired (step S52; No) or when the process of step S53 has ended, the information process ends.

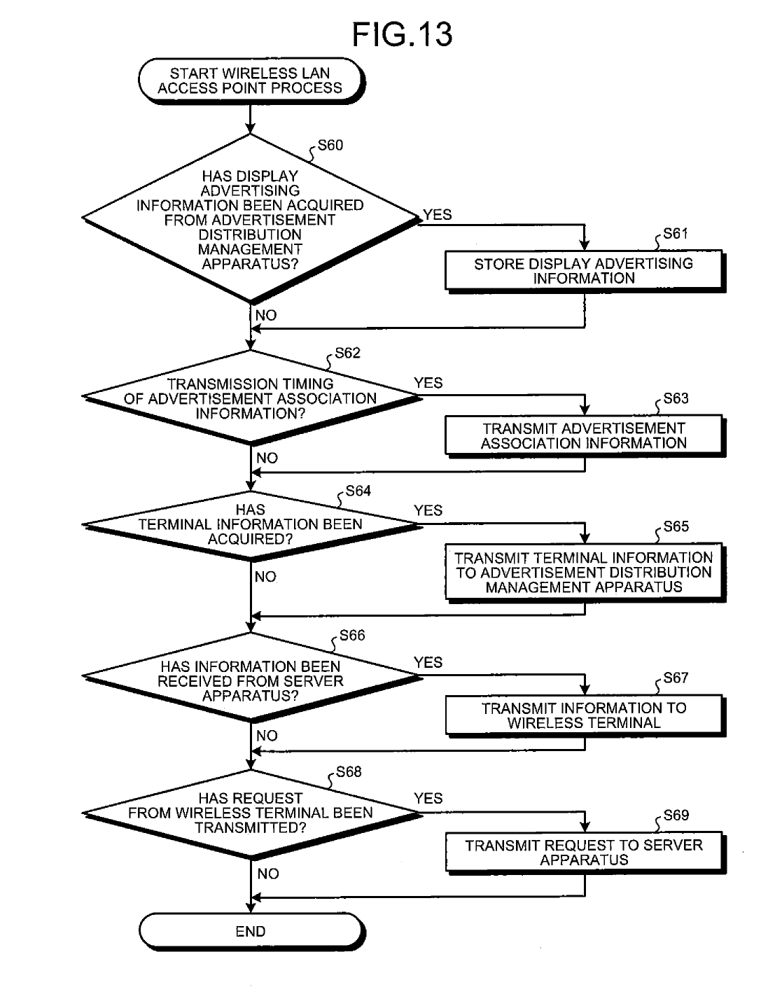

Next, an information process of the wireless LAN access point 3A will be described with reference to FIG. 13. FIG. 13 is a flowchart of the information process in the wireless LAN access point 3A. This operation is a process executed repetitively by the control unit 23A of the wireless LAN access point 3A. The processes of steps S66 to S69 of FIG. 13 are the same as the processes of steps S22 to S25 of FIG. 8 and explanation thereof is omitted hereinafter.

As illustrated in FIG. 13, the control unit 23A of the wireless LAN access point 3A determines whether the display advertisement information including the advertisement ID and the advertisement display time of the advertising content displayed by the digital signage 4 has been acquired from the advertisement distribution management apparatus 5A through the communication unit 22 (step S60). When it is determined that the display advertisement information has been acquired (step S60; Yes), the control unit 23A stores the display advertisement information (step S61).

When it is determined that the display advertisement information has not been acquired (step S60; No) or when the process of step S61 has ended, the control unit 23A determines that transmission timing of the advertisement association information has come (step S62). When it is determined that the transmission timing of the advertisement association information has come (step S62; Yes), the control unit 23A transmits the advertisement association information to the wireless terminal 2A (step S63).

When it is determined that the transmission timing of the advertisement association information has not come (step S62; No) or when the process of step S63 has ended, it is determined whether the terminal information has been acquired from the wireless terminal 2A through the wireless LAN communication unit 21 (step S64). In this process, when it is determined that the terminal information has been acquired (step S64: Yes), the acquired terminal information is transmitted to the advertisement distribution management apparatus 5A (step S65). Then, the process after step S66 is executed.

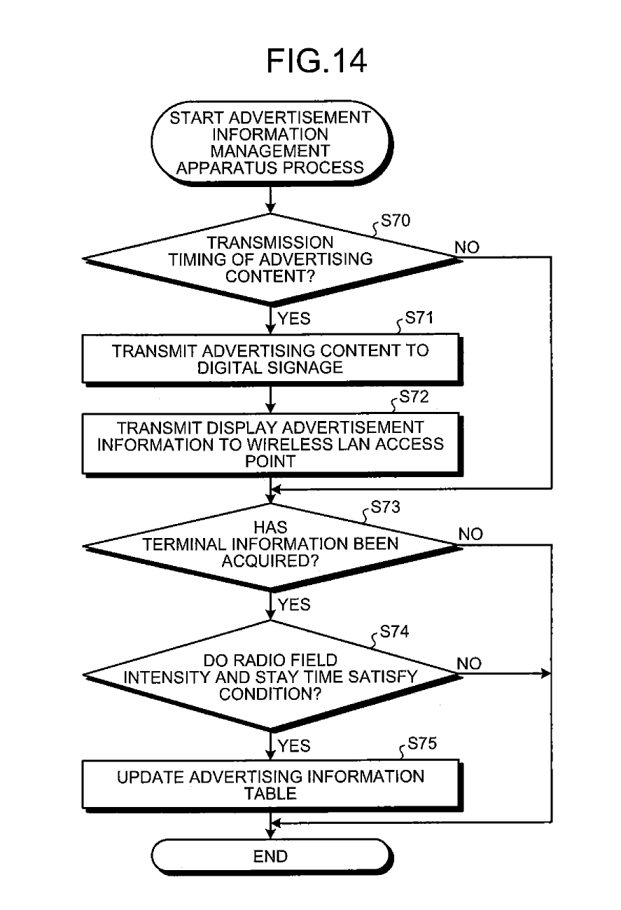

Next, a process of the advertisement distribution management apparatus 5A will be described. FIG. 14 is a flowchart of the information process in the advertisement distribution management apparatus 5A. This operation is a process executed repetitively by the control unit 32A of the advertisement distribution management apparatus 5.

As illustrated in FIG. 14, the control unit 32A determines whether the transmission timing of the advertising content to the digital signage 4 has come, on the basis of the DS information table (step S70). When it is determined that the transmission timing has come (step S70; Yes), the control unit 32A executes the process of step S71 and the process of step S72.

In the process of step S71, the control unit 32A reads the advertising content of which the transmission timing has come from the advertising information DB 41 and transmits the advertising content to the digital signage 4 through the communication network 7. In addition, in the process of step S72, the control unit 32A transmits the display advertisement information including the advertisement ID of the advertising content transmitted in step S71 to the wireless LAN access point 3A corresponding to the digital signage 4.

When it is determined that the transmission timing has not come (step S70; No) or when the process of step S72 has ended, the control unit 32A determines whether the terminal information of the wireless terminal 2A has been acquired from the wireless LAN access point 3A through the communication unit 30 (step S73). When it is determined that the terminal information of the wireless terminal 2A has been acquired (step S73; Yes), the control unit 32A sets the wireless terminal 2A corresponding to the terminal information as the remitting customer target candidate terminal. In addition, the control unit 32A determines whether the radio field intensity and the stay time of the remitting customer target candidate terminal in the remitting customer side communication area satisfy the count condition set in the count determination table (step S74).

When it is determined that the radio field intensity and the stay time of the remitting customer target candidate terminal satisfy the count condition (step S74; Yes), the control unit 32A increments the remitting customer count value corresponding to the remitting customer target candidate terminal in the advertising information table and updates the advertising information table (step S75). When it is determined that the terminal information of the wireless terminal 2A has not been acquired (step S73; No), when it is determined that the radio field intensity and the stay time of the remitting customer target candidate terminal do not satisfy the count condition (step S74; No), or when the process of step S75 has ended, the information process of the control unit 32A ends.

As described above, the advertising system 1A according to the second embodiment stores the information regarding the advertising content displayed by the digital signage 4 of the remitting customer side communication area in the wireless terminal 2A. In addition, when the wireless terminal 2A has entered the attracting customer side communication area, the advertisement distribution management apparatus 5A acquires the terminal information including the information regarding the advertising content from the wireless terminal 2A through the wireless LAN access point 3A. The advertisement distribution management apparatus 5A can detect the wireless terminal 2A having entered the remitting customer side communication area after having entered the remitting customer side communication area, on the basis of the terminal information of the wireless terminal 2A, and updates information on a result of remitting customer by the advertising content, on the basis of a detection result. Thereby, an advertising effect by the advertising content can be determined quickly and appropriately.

In the second embodiment described above, the control unit 32A sets the wireless terminal 2A corresponding to the terminal information as the remitting customer target candidate terminal and determines whether the radio field intensity and the stay time of the remitting customer target candidate terminal in the remitting customer side communication area satisfy the count condition. However, this process may be executed by the wireless terminal 2A. For example, the control unit 32A acquires the corresponding count condition from the count determination table and transmits the count condition to the wireless LAN access point 3A and the wireless LAN access point 3A transmits the information on the count condition to the wireless terminal 2A. The control unit 63 of the wireless terminal 2A determines whether it becomes an increment target of the remitting customer count value, on the basis of the count condition acquired from the wireless LAN access point 3A and the terminal information. When it is determined that it becomes an increment target of the remitting customer count value, the control unit 63 of the wireless terminal 2A transmits an increment request to the wireless LAN access point 3A and the increment request is transmitted from the wireless LAN access point 3A to the advertisement distribution management apparatus 5A. If the advertisement distribution management apparatus 5A receives the increment request, the advertisement distribution management apparatus 5A increments the remitting customer count value corresponding to the increment request.

In addition, in the second embodiment described above, the control unit 63 of the wireless terminal 2A determines whether the wireless terminal 2A is the remitting customer target candidate terminal. However, the control unit 23A of the wireless LAN access point 3A may perform the determination. In this case, the control unit 32A of the advertisement distribution management apparatus 5A transmits the advertisement ID and the attracting customer side AP-ID (refer to FIG. 5) to the wireless LAN access point 3A. If the wireless terminal 2A enters the AP communication area 6, the wireless terminal 2A transmits the terminal information. If the control unit 23A of the wireless LAN access point 3A acquires the terminal information from the wireless terminal 2A, the control unit 23A transmits the terminal information from the wireless terminal 2A to the advertisement distribution management apparatus 5A, when the AP-ID included in the terminal information is matched with the attracting customer side AP-ID acquired from the advertisement distribution management apparatus 5A.

In addition, in the second embodiment described above, the control unit 63 of the wireless terminal 2A determines whether the wireless terminal 2A is the remitting customer target candidate terminal. However, the control unit 32A of the advertisement distribution management apparatus 5A may perform the determination. In this case, if the wireless terminal 2A enters the AP communication area 6, the wireless terminal 2A transmits the terminal information. If the control unit 23A of the wireless LAN access point 3A acquires the terminal information from the wireless terminal 2A, the control unit 23A adds the AP-ID of the own apparatus to the terminal information from the wireless terminal 2A and transmits the terminal information to the advertisement distribution management apparatus 5A. The control unit 32A of the advertisement distribution management apparatus 5A determines whether the wireless terminal 2A is the remitting customer target candidate terminal, on the basis of the information transmitted from the wireless LAN access point 3A, by the same determination method as the control unit 32.

### 3. Modification

In the embodiments described above, the example of the case in which the wireless terminal 2 (2A) enters the AP communication area 6 and leaves the AP communication area 6 while one piece of advertising content is displayed on the digital signage 4 has been described. However, when a plurality of pieces of advertising content is displayed on the digital signage 4 while the wireless terminal 2 (2A) enters the AP communication area 6 and leaves the AP communication area 6, an update process of a remitting customer count value for each advertising content is executed. In this case, the update unit 53 (53A) may execute the update process of the remitting customer count value of one of the plurality of pieces of advertising content, according to the radio field intensity or the stay time. For example, the update unit 53 (53A) executes the update process of the remitting customer count value of the advertising content of which the radio field intensity is strong or the stay time is long.

In addition, when there is the wireless terminal 2 (2A) having entered the attracting customer side communication area after having entered one or more remitting customer side communication areas, the update unit 53 (53A) executes the update process of the remitting customer count value of the advertising content. However, the present invention is not limited to this process. For example, when there is the wireless terminal 2 (2A) having entered the same attracting customer side communication area after having entered the plurality of remitting customer side communication areas, for example, the control unit 32 (32A) can increment the remitting customer count value of the advertising content, according to the number of remitting customer side communication areas which the wireless terminal has entered.

In addition, when there is the wireless terminal 2 (2A) having entered the attracting customer side communication area after having entered the remitting customer side communication area, the update unit 53 (53A) executes the update process of the remitting customer count value of the advertising content. However, when the number of times or the frequency of having entered the attracting customer side communication area before the wireless terminal 2 (2A) has entered the remitting customer side communication area is a predetermined threshold value or more, the update process of the remitting customer count value of the advertising content may not be executed.

In addition, in the embodiments described above, the distribution unit 51 (51A) transmits the advertising content to the digital signage 4, on the basis of the information set in the DS information table. However, the distribution unit can select the digital signage 4 to transmit the advertising content, on the basis of other information.

For example, the distribution unit 51 (51A) can select the digital signage 4 to transmit the advertising content, according to the remitting customer count value. For example, in an initial step in which the display of the advertising content on the digital signage 4 starts, the distribution unit 51 (51A) transmits the advertising content to the plurality of digital signages 4. Then, the distribution unit 51 (51A) narrows the digital signages 4 to the digital signages 4 of the remitting customer side communication area having contributed to updating of the remitting customer count value and transmits the advertising content to the digital signages. For example, the distribution unit 51 (51A) determines the digital signages 4 of the predetermined number in which a contribution ratio of the updating of the remitting customer count value is high and transmits the advertising content to the digital signages 4.

In addition, the distribution unit 51 (51A) can select the digital signage 4 to transmit the advertising content, on the basis of the kind (for example, a selling product) of the commercial space of the AP communication area 6. For example, the advertising content is transmitted to the digital signage 4 arranged in the commercial space of the kind corresponding to the kind of the advertising content. In addition, the distribution unit 51 (51A) can select the digital signage 4 to transmit the advertising content, on the basis of the user information of the wireless terminal 2 (2A) existing in the AP communication area 6.

In addition, in the embodiments described above, when there is the wireless terminal 2 (2A) having entered the attracting customer side communication area after having entered the remitting customer side communication area, the update unit 53 (53A) executes the update process of the remitting customer count value of the advertising content. However, when a time until the wireless terminal enters the attracting customer side communication area after entering the remitting customer side communication area is a predetermined time or more, the update unit 53 (53A) may not execute the update process of the remitting customer count value. For example, when the time until the wireless terminal enters the attracting customer side communication area after entering the remitting customer side communication area is one week or more, the update unit 53 (53A) does not execute the update process of the remitting customer count value.

### 4. Effect

As described above, the advertising systems 1 and 1A according to the embodiments include the wireless LAN access points 3 and 3A (one example of a remitting customer side wireless LAN communication unit) arranged at the positions corresponding to the digital signage 4 on which the advertising content is displayed and the wireless LAN access points 3 and 3A (one example of an attracting customer side wireless LAN communication unit) arranged in the commercial space that is the advertisement target of the advertising content, respectively. In addition, when the wireless terminals 2 and 2A enters the attracting customer side communication area after entering the remitting customer side communication area is detected, the update units 53 and 53A (one example of a remitting customer result update unit) update the remitting customer count value (one example of a result of remitting customer by the advertising content) of the advertising content.

Because it can be estimated that the users of the wireless terminals 2 and 2A that enter the attracting customer side communication area after entering the remitting customer side communication area in which the advertising content is displayed is guided to the attracting customer side communication area by the advertising content, an advertising effect by the advertising content can be determined quickly and appropriately on the basis of the remitting customer count value, by the above configuration.

In addition, the acquisition unit 52 (one example of a remitting customer side information acquisition unit) acquires the information on the wireless terminal 2 that enters the remitting customer side communication area, the storage unit 31 (one example of a remitting customer information storage unit) stores the information on the wireless terminal 2 acquired by the acquisition unit 52, the acquisition unit 52 (one example of an attracting customer side information acquisition unit) acquires the information on the wireless terminal 2 that enters the attracting customer side communication area, and the update unit 53 updates the remitting customer count value of the advertising content, when the information on the wireless terminal 2 acquired by the acquisition unit 52 (one example of an attracting customer side information acquisition unit) is stored in the storage unit 31.

By the above configuration, the remitting customer count value of the advertising content can be updated in the wireless terminal 2 without recognizing that the wireless terminal enters the remitting customer side communication area or that the wireless terminal enters the attracting customer side compunction area. Therefore, processing load in the wireless terminal 2 can be alleviated.

In addition, the storage unit 31 (one example of a remitting customer information storage unit) stores the information on the wireless terminal 2 detected by the acquisition unit 52 (one example of a remitting customer side information acquisition unit) in association with the information on the advertising content displayed on the digital signage 4 and stores the information and the update unit 53 (one example of a remitting customer result update unit) updates the remitting customer count value of the advertising content associated with the information on the wireless terminal 2, when the information on the wireless terminal 2 acquired by the acquisition unit 52 (one example of an attracting customer side information acquisition unit) is stored in the storage unit 31 (one example of a remitting customer information storage unit).

By the above configuration, when there is the wireless terminal 2 that enters the attracting customer side communication area after entering the remitting customer side communication area, the remitting customer count value can be updated with ease and with high precision.

In addition, the information on the wireless terminal 2 is the identification information peculiar to the wireless terminal 2, the acquisition unit 52 (one example of a remitting customer side information acquisition unit) acquires the identification information peculiar to the wireless terminal 2 from the wireless terminal 2 that enters the remitting customer side communication area, and the acquisition unit 52 (one example of an attracting customer side information acquisition unit) acquires the identification information peculiar to the wireless terminal 2 from the wireless terminal 2 that enters the attracting customer side communication area.

By the above configuration, the wireless terminal 2 can be identified appropriately. Thereby, the remitting customer count value can be updated with high precision.

In addition, the distribution unit 51A (one example of a remitting customer information transmission unit) transmits the identification information of the advertising content to the wireless terminal 2 that enters the remitting customer side communication area, the acquisition unit 52A (one example of a remitting customer information acquisition unit) acquires the identification information of the advertising content from the wireless terminal 2A that enters the attracting customer side communication area, and the update unit 53A (one example of a remitting customer result update unit) updates the remitting customer count value of the advertising content, when the identification information of the advertising content is acquired from the wireless terminal 2A in which the information is acquired by the acquisition unit 52A (one example of a remitting customer information acquisition unit).

By the above configuration, it is not necessary to acquire the detection information and manage the detection information by the advertisement distribution management apparatus 5A and processing load of the advertisement distribution management apparatus 5A can be alleviated.

In addition, the update units 53 and 53A (one example of a remitting customer result update unit) update the remitting customer count value of the advertising content, when the radio field intensity and/or the stay time of the wireless terminals 2 and 2A that enters the attracting customer side communication area after entering the remitting customer side communication area in the remitting customer side communication area satisfies the predetermined count condition.

By the above configuration, the wireless terminal 2 (2A) which is highly likely to view the digital signage 4 can be set as the update target of the remitting customer count value. Thereby, an advertising effect by the advertising content can be determined with higher precision.

In addition, the determination unit 54 (one example of a determination unit) determines a value of a price for displaying the advertising content on the digital signage 4, on the basis of the remitting customer count value.

By the above configuration, setting of appropriate advertisement charges matched with an advertising effect by the advertising content can be performed.

### 5. Others

In addition, the advertisement distribution management apparatus 5 (5A) may be realized by a plurality of server computers or may be realized by calling an external platform by an application programming interface (API) or network computing depending on functions and thus a configuration can be flexibly changed. In addition, a part of the functions of the advertisement distribution management apparatus 5 (5A) may be realized by the wireless LAN access point 3 (3A).

According to an aspect of the embodiment, an advertising system and an advertising effect determination method that can determine an advertising effect by a digital signage can be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertising system comprising:
a remitting customer side wireless LAN communication unit that is arranged at a position corresponding to a digital signage on which advertising content is displayed;
an attracting customer side wireless LAN communication unit that is arranged in a commercial space that is an advertisement target of the advertising content; and
a remitting customer result update unit configured to update information on a result of remitting customer by the advertising content, when a wireless terminal that enters a communication area of the attracting customer side wireless LAN communication unit after entering a communication area of the remitting customer side wireless LAN communication unit is detected.

2. The advertising system according to claim 1, further comprising:
a remitting customer side information acquisition unit configured to acquire information on the wireless terminal that enters the communication area of the remitting customer side wireless LAN communication unit;
a remitting customer information storage unit configured to store the information on the wireless terminal acquired by the remitting customer side information acquisition unit; and
an attracting customer side information acquisition unit configured to acquire information on the wireless terminal that enters the communication area of the attracting customer side wireless LAN communication unit,
wherein the remitting customer result update unit updates the information on the result of remitting customer, when the information on the wireless terminal acquired by the attracting customer side information acquisition unit is stored in the remitting customer information storage unit.

3. The advertising system according to claim 2,
wherein the remitting customer information storage unit stores information on the wireless terminal on which the information is acquired by the remitting customer side information acquisition unit in association with information on the advertising content displayed on the digital signage and stores the information, and
the remitting customer result update unit updates the information on the result of remitting customer by the advertising content associated with the information on the wireless terminal, when the information on the wireless terminal acquired by the attracting customer side information acquisition unit is stored in the remitting customer information storage unit.

4. The advertising system according to claim 1, further comprising:
a remitting customer information transmission unit configured to transmit identification information of the advertising content to the wireless terminal that enters the communication area of the remitting customer side wireless LAN communication unit; and
a remitting customer information acquisition unit configured to acquire the identification information of the advertising content from the wireless terminal that enters the communication area of the attracting customer side wireless LAN communication unit,
wherein the remitting customer result update unit updates the information on the result of remitting customer, when the remitting customer information acquisition unit acquires the identification information of the advertising content from the wireless terminal.

5. The advertising system according to claim 2,
wherein the remitting customer result update unit updates the information on the result of remitting customer, when a radio field intensity and/or a stay time of the wireless terminal, which enters the communication area of the attracting customer side wireless LAN communication unit after entering the communication area of the remitting customer side wireless LAN communication unit, in the communication area of the remitting customer side wireless LAN communication unit satisfies a predetermined condition.

6. The advertising system according to claim 1, further comprising:
a determination unit configured to determine a value of a price for displaying the advertising content on the digital signage, on the basis of the information on the result of remitting customer.

7. An advertising effect determination method comprising:
firstly acquiring information on a wireless terminal that enters a communication area of a remitting customer side wireless LAN communication unit arranged at a position corresponding to a digital signage on which advertising content is displayed;
storing the information on the wireless terminal acquired in the firstly acquiring in a remitting customer information storage unit;
secondary acquiring information on a wireless terminal that enters a communication area of an attracting customer side wireless LAN communication unit arranged in a commercial space that is an advertisement target of the advertising content; and
updating information on a result of remitting customer by the advertising content, when the information on the wireless terminal detected in the secondary acquiring is stored in the remitting customer information storage unit.

8. An advertising effect determination method comprising:
transmitting identification information of advertising content to a wireless terminal that enters a communication area of a remitting customer side wireless LAN communication unit arranged at a position corresponding to a digital signage on which the advertising content is displayed;
acquiring the identification information of the advertising content from a wireless terminal that enters a communication area of an attracting customer side wireless LAN communication unit arranged in a commercial space that is an advertisement target of the advertising content; and
updating information on a result of remitting customer by the advertising content, when the identification information of the advertising content that acquires from the wireless terminal in the acquiring.
